(19) United States
(12) Patent Application Publication
(10) Pub. No.: US 2016/0012544 A1
(43) Pub. Date: Jan. 14, 2016

(54) INSURANCE CLAIM VALIDATION AND ANOMALY DETECTION BASED ON MODUS OPERANDI ANALYSIS

(71) Applicants: Sridevi Ramaswamy, Fremont, CA (US); Kirubakaran Pakkirisamy, San Ramon, CA (US); John Standish, Menifee, CA (US); Martin Maylor, Alberta (CA)

(72) Inventors: Sridevi Ramaswamy, Fremont, CA (US); Kirubakaran Pakkirisamy, San Ramon, CA (US); John Standish, Menifee, CA (US); Martin Maylor, Alberta (CA)

(21) Appl. No.: 14/723,426

(22) Filed: May 27, 2015

Related U.S. Application Data
(60) Provisional application No. 62/003,548, filed on May 28, 2014.

(51) Int. Cl. G06Q 40/08

(52) U.S. Cl. CPC G06Q 40/08

(57) ABSTRACT

In one aspect, a method of computer-implemented insurance claim validation based on ARM (pattern analysis, recognition and matching) approach and anomaly detection based on modus operandi analysis including the step of obtaining a set of open claims data. One of more modus-operandi variables of the open claims set are determined. A step includes determining a match between the one or more modus operandi variables and a claim in the set of open claims. A step includes generating a list of suspected fraudulent claims that comprises each matched claim. A step includes implementing one or more machine learning algorithms to learn a fraud signature pattern in the list of suspected fraudulent claims. A step includes grouping the set of open claims data based on the fraud signature pattern as determined by the modus operandi variables.

### CROSS-REFERENCE TO RELATED APPLICATIONS

This application is a claims priority from U.S. Provisional Application No. 62/003,548, titled INSURANCE CLAIM VALIDATION AND ANOMALY DETECTION BASED ON MODUS OPERANDI ANALYSIS and filed 28 May 2014. This application is hereby incorporated by reference in its entirety.

### BACKGROUND

1. Field

This application relates generally to computerized insurance and anomaly detection methods, and more specifically to a system, article of manufacture and method for insurance claim validation and/or anomaly detection based on modus operandi analysis.

2. Related Art

There is a need for software tools to enable claims department personnel and special investigations units (SIU) with investigation and analysis techniques and aid them in determining the validity of insurance claims. Some existing solutions either do analysis only on structured data within the claims or, where they do analysis on unstructured data, provide only results on basic text and link analysis to the user. These methods have several drawbacks. For example, they may be prone to providing too many false positives. This can place the onus on the user to sift through the presented results and determine validity of claims. These methods can also provide too much information to the user. For example, often all possible links from a claim may be displayed. Again, the onus is placed on the user to sift through the presented results and determine their validity of claims. Consequently, these methods may decrease the user's efficiency and speed of review. Accordingly, a software tool that can automate more detailed analysis techniques on claims can reduce the number of false positives, while performing the analysis in comparable or shorter time as existing solutions, thus quickly and effectively segregating suspicious claims from genuine ones.

Another need is for software tools to enable claims department personnel, special investigations units (SIU) and law enforcement with investigation and analysis techniques and aid them in detecting organized crime and repeat offenders. Often repeat offenders return into the system under pseudonyms and simple techniques focusing on single point analysis fall short. A lot of the information is hidden in unstructured data and advanced analytics techniques that mine information from unstructured data and correlate that with other sources of data such as social media are required.

### SUMMARY OF INVENTION

A method of computer-implemented insurance claim validation based on ARM (pattern analysis, recognition and matching) approach and anomaly detection based on modus operandi analysis including the step of obtaining a set of open claims data. One of more modus-operandi variables of the open claims set are determined. A step includes determining a match between the one or more modus operandi variables and a claim in the set of open claims. A step includes generating a list of suspected fraudulent claims that comprises each matched claim. A step includes implementing one or more machine learning algorithms to learn a fraud signature pattern in the list of suspected fraudulent claims. A step includes grouping the set of open claims data based on the fraud signature pattern as determined by the modus operandi variables.

### BRIEF DESCRIPTION OF THE DRAWINGS

FIG. 1 depicts an example process of insurance claim validation and/or anomaly detection based on modus operandi analysis, according to some embodiments.

FIG. 2 illustrates an example table of modus operandi indicators, according to some embodiments.

FIG. 3 illustrates, in block diagram format, an example insurance claims analysis system, according to some embodiments.

FIG. 4 is a block diagram of a sample computing environment that can be utilized to implement various embodiments.

FIG. 5 depicts computing system with a number of components that may be used to perform any of the processes described herein.

FIG. 6 illustrates an example process for insurance and anomaly detection methods, according to some embodiments.

The Figures described above are a representative set, and are not an exhaustive with respect to embodying the invention.

### DESCRIPTION

Disclosed are a system, method, and article of manufacture of computer-implemented insurance claim validation based on ARM (pattern analysis, recognition and matching) approach and anomaly detection based on modus operandi analysis. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” ‘one example,’ or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Example Definitions and Example Algorithms

Claims leakage can include pecuniary loss through claims management inefficiencies that result from failures in existing processes (e.g. manual and/or automated).

Insurance claim can be a demand for payment in accordance with an insurance policy.

Insurance fraud can be any act or omission with a view to illegally obtaining an insurance benefit.

Machine learning can be a branch of artificial intelligence concerned with the construction and study of systems that can learn from data. Machine learning techniques can include, inter alia: decision tree learning, association rule learning, artificial neural networks, inductive logic programming, support vector machines, clustering, Bayesian networks, reinforcement learning, representation learning, similarity and metric learning and/or sparse dictionary learning.

Modus Operandi (MO) can include the methods employed or behaviors exhibited by the perpetrators to commit crimes such as insurance fraud. MO can consist of examining the actions used by the individual(s) to execute a crime, prevent detection of the crime and/or facilitate escape. MO can be used to determine links between crimes.

Pattern matching algorithms can check a given sequence of tokens for the presence of the constituents of some pattern. The patterns generally have the form of either sequences or tree structures. Pattern matching can include outputting the locations (if any) of a pattern within a token sequence, to output some component of the matched pattern, and to substitute the matching pattern with some other token sequence (i.e., search and replace). In some embodiments, pattern recognition algorithms can also be utilized in lieu of or in addition to pattern matching algorithms.

Sequence patterns (e.g., a text string) are often described using regular expressions and matched using techniques such as backtracking.

Predictive analytics can include statistical techniques such as modeling, machine learning, and/or data mining that analyze current and/or historical facts to make predictions about future, or otherwise unknown, events. Various models can be utilized, such as, inter alia: predictive models, descriptive models and/or decision models.

Pattern analysis, Recognition and Matching (ARM) approach refers to a methodology of claims validation, wherein claims data is analyzed to detect patterns and any recognized patterns are matched against known pattern signatures to identify the MO of the perpetrator.

### Example Methods

Computerized methods and systems of an ARM approach with modus operandi (MO) approach for performing claims validation and/or advanced analysis can be used to reduce false positives and/or claims leakage. Various MO variables can be determined for a large volume of claims. A list of open claims can be used to generate a shorter list of Suspected Fraudulent Claims (SFC). Non-SFC claims can be fast tracked as genuine claims. The SFC list can then be investigated for further/deeper analysis (e.g. by other specialized algorithms, by human investigators, etc.). A machine learning approach can learn fraud and non-fraud signatures/patterns (e.g. based on user confirming whether a SFC is a fraud or not). This information can be used to refine the SFC list with respect to accuracy. A view of related groups of claims (e.g. SFC or otherwise) related by the MO variables can be provided. Visually selection of a group and/or part of the group for further analysis can be performed.

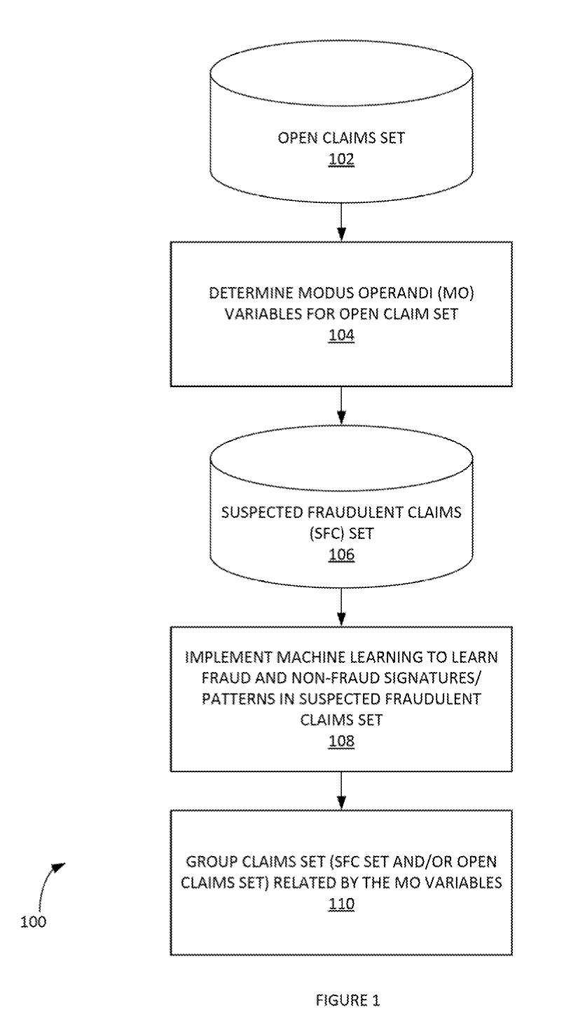

FIG. 1 depicts an example process 100 of insurance claim validation and/or anomaly detection based on MO analysis, according to some embodiments. An open claims set 102 can be obtained. In step 104 of process 100, the MO variables of the open claims set 102 can be determined. The values of the MO variables can also be determined. Step 104 can be used to generate an SFC set 106. In step 108, machine learning algorithms can be implemented to learn fraud and/or non-fraud signatures/patterns in SFC set 106. In step 110, claims sets can be grouped (e.g. SFC set 106 and/or open claims set 102) by MO variables identified in step 104.

For example, every claim that is processed (e.g. claims in the open claims set 102), the various MO indicators can be identified. Various combinations of various analyses techniques can be implemented to identify MO indicators associated with a given claim. Example types of analysis include, inter alia: text analysis, social analysis, link analysis, statistical analysis, transaction analysis and/or predictive analyses. It can also include various artificial intelligence techniques such as expert systems, neural networks, and the like. The SFC method can then be applied on the MO indicators for each claim to generate a signature for that claim. If a signature that could signify suspected fraud is found associated with a claim, the claim can then be flagged as an SFC claim. A combination of various techniques and advanced algorithms can be used to identify whether a given signature signifies suspected fraud. Example techniques and advanced algorithms, include, inter alia: expert systems, signature aspect formula (see infra), etc. Each SFC can be compared against other SFCs in an available database of claims. Based on these comparisons, SFCs can be grouped such that SFCs having the same or similar signatures are included in the same group(s). There is a high likelihood that SFCs in the same grouping are potential frauds committed by the same person or group of persons. Based on the grouping(s) a given claim falls in, artificial intelligence techniques can then be implemented to recommend appropriate courses of action to the user of the system (e.g. claims department, special investigations unit, etc.). User feedback and/or machine learning techniques can be implemented to detect and/or learn new MO indicators, MO indicator patterns, SFC and non-SFC signatures, and/or create new SFC buckets.

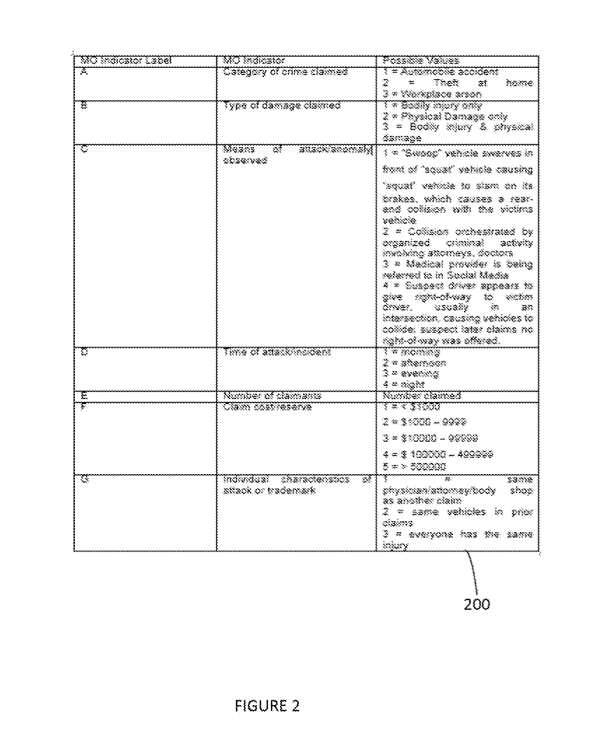

FIG. 2 illustrates an example table 200 of MO indicators, according to some embodiments. Table 200 can include columns that define MO indicator labels, MO indicators and possible MO indicator values. Table 200 is provided by way of example and not of limitation. Table 200 can be instantiated in software and implemented with at least one processor. In one example, using process 100, a database can include twenty (20) prior claims. Four (4) have been previously flagged as SFC and three (3) have been confirmed to be genuine claims. The SFC-flagged claims can have associated. For example, claims ‘531’, ‘1022’, ‘10123’ and ‘10234’ can have been flagged as SFC. Claims ‘123’, ‘678’ and ‘985’ can have been confirmed to be non-SFC. Signature Aspect Formula (SAF) database that may have the following rules as defined in the following table:

IF (A and B and C and D and E and F and G) THEN Flag as SFC
IF (A and B and D and E and F and (C or G)) THEN Flag as SFC
IF (C or G) THEN Flag as SFC

These rules can be used to identify genuine claims and define a claim as SFC. For example, a new claim ‘14567’ has been reported and First Notice of Loss (FNOL) generated. It is entered into the software system for analysis. Process 100 can be implemented using table 200 to identify the MO indicators for claim #14567 as indicated in the following table.

| MO Indicator | Value |
|---|---|
| A | 1 (automobile) |
| B | 3 (Bodily injury and physical damage) |
| C | 1, 2 and 3 |
| | “Swoop” vehicle swerves in front of “squat” |
| | vehicle causing “squat” vehicle to slam on |
| | its brakes, which causes a rear-end collision |
| | with the victims vehicle |
| | Collision orchestrated by organized criminal |
| | activity involving attorneys, doctors, |
| | Medical provider is being referred to in |
| | Social Media |
| D | 1 (morning) |
| E | 4 claimants |
| F | 3 (claim cost/reserve around 10K) |
| G | 1 (same attorney found in prior SFCs - |
| | claim # 531, 1022 and 10234) |

Accordingly, the claim signature for ‘14567’ can be {A1, B3, C (1,2,3), D1, E4, F3, G1}. It can be determined from the SAF database that the rule ‘IF (A and B and C and D and E and F and G) THEN Flag as SFC’ applies to claim ‘14567’. Consequently, claim ‘14567’ can be flagged as a suspected fraudulent claim. An appropriate entity (e.g. claims department) can be notified for further investigation.

The signature of claim ‘14567’ can then be compared against other SFC claims in the claims database. In this example, claims ‘531’, ‘1022’ and ‘14567’ can be identified as sufficiently similar. Accordingly, the result to the appropriate entity for further investigation.

Continuing with the example, the handling of claims ‘531’ and ‘1022’ can be reviewed. A recommendation can be provided to the appropriate entity the following actions be taken, inter alia: confirm the time of the accident from all parties and check for correlation; determine additional information about the locations of each accident; inquired what are the exact repairs/medical procedures to be performed and confirm costs of said actions sum to $10,000.

In one example, a claims department investigator can then investigates claims ‘531’ and ‘1022’ based on information provided. Several possible outcomes can be reached. Upon further investigation, the claims department investigator can confirm that a claim is indeed genuine. The investigator can enters this information in the database. Claim ‘14657’ can then be marked as genuine. Based on the information provided by claims department person, the system can using machine learning algorithms to determine why claims ‘531’ and ‘1022’ were marked SFC while claim ‘14657’ was not. The system's MO indicators and SAF rules can then be updated.

In another example, upon further investigation, the claims department investigator can confirms that the claim is indeed fraudulent. The investigator can enter this information in the database. The system can mark claim ‘14657’ as ‘confirmed fraudulent’. The system can use machine learning algorithms to learn from this and update the system's MO indicators and SAF rules accordingly.

In yet another example, upon further investigation, the claims department investigator may be unable to confirm whether the claim is fraudulent or genuine. The investigator and enter this information into the database. Since the claim could not be confirmed as fraudulent, the claims department can pay off the claim. However, the system may maintain claim ‘14657’ marked as SFC. The system can use machine learning algorithms to learn from this and update the system's MO indicators and SAF rules accordingly.

As another example, a new claim ‘156789’ has been reported and FNOL generated. It is entered into the software system for analysis. Process 100 can be implemented using table 200 to identify the MO indicators for claim #156789 as indicated in the following table.

| MO Indicator | Value |
|---|---|
| A | 1 (automobile) |
| B | 3 (Bodily injury and physical damage) |
| D | 1 (morning) |
| E | 4 claimants |
| F | 3 (claim cost/reserve round 10K) |

Accordingly, the claim signature for ‘156789’ can be {A1, B3, D1, E4, F3}. It can be determined from the SAF database that none of the specified rules applies to claim ‘156789’. Consequently, claim ‘156789’ can be fast tracked as a genuine claim.

### Example Systems and Architecture

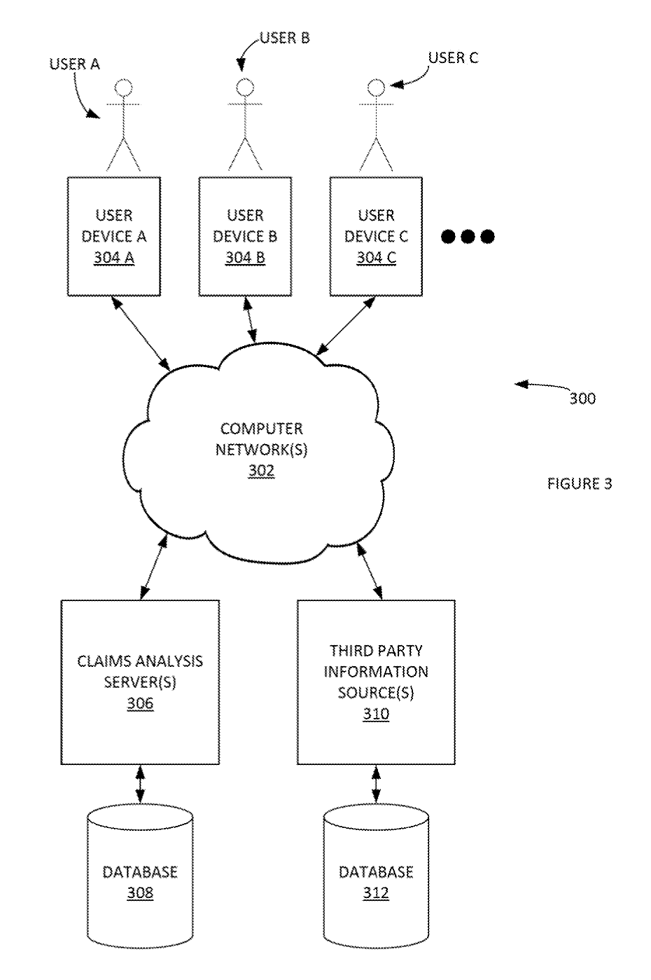

FIG. 3 illustrates, in block diagram format, an example insurance claims analysis system 300, according to some embodiments. System 300 can implement process 100 and the methods provided in the description of FIG. 2. System 300's implementation can include, inter alia, advanced analytics, algorithms and a unique SAF needed to validate the claims before flagging them as SFC. SAF can be implemented through various machine computing/artificial intelligence techniques such as “Expert System”.

More specifically, system 300 can include one or more computer network(s) 302 (e.g. the Internet, enterprise WAN, cellular data networks, etc.). User devices 304 A-C can include various functionalities (e.g. client-applications, web browsers, and the like) for interacting with a claims analysis server (e.g. claims analysis server(s) 306). Users can be investigating entities such as, inter alia, claims department personnel in insurance companies and/or SIU personnel.

Claims analysis server(s) 306 can provide and manage a claims analysis service. In some embodiments, claims analysis server(s) 306 can be implemented in a cloud-computing environment. Claims analysis server(s) 306 can include the functionalities provided herein, such those of FIGS. 1-2. Claims analysis server(s) 306 can include web servers, database managers, functionalities for calling API's of relevant other systems, AI systems, data scrappers, natural language processing functionalities, ranking functionalities, statistical modelling and sampling functionalities, search engines, machine learning systems, email modules (e.g. automatically generate email notifications and/or claims analysis data to users), expert systems, signature aspect formula modules, text analysis modules, etc. Claims analysis server(s) 306 can implement various statistical and probabilistic algorithms to rank various elements of the claims analysis website. For example, claims analysis information in the database 308 can be automatically sampled by the statistical algorithm. There are several methods which may be used to select a proper sample size and/or use a given sample to make statements (within a range of accuracy determined by the sample size) about a specified population. These methods may include, for example:
1. Classical Statistics as, for example, in “Probability and Statistics for Engineers and Scientists” by R. E. Walpole and R. H. Myers, Prentice-Hall 1993; Chapter 8 and Chapter 9, where estimates of the mean and variance of the population are derived.
2. Bayesian Analysis as, for example, in “Bayesian Data Analysis” by A Gelman, I. B. Carlin, H. S. Stern and D. B. Rubin, Chapman and Hall 1995; Chapter 7, where several sampling designs are discussed.
3. Artificial Intelligence techniques, or other such techniques as Expert Systems or Neural Networks as, for example, in “Expert Systems: Principles and Programming” by Giarratano and G. Riley, PWS Publishing 1994; Chapter 4, or “Practical Neural Networks Recipes in C++” by T. Masters, Academic Press 1993; Chapters 15, 16, 19 and 20, where population models are developed from acquired data samples.
4. Latent Dirichlet Allocation, Journal of Machine Learning Research 3 (2003) 993-1022, by David M. Blei, Computer Science Division, University of California, Berkeley, Calif. 94720, USA, Andrew Y. Ng, Computer Science Department, Stanford University, Stanford, Calif. 94305, USA

It is noted that these statistical and probabilistic methodologies are for exemplary purposes and other statistical methodologies can be utilized and/or combined in various embodiments. These statistical methodologies can be utilized elsewhere, in whole or in part, when appropriate as well.

Claims analysis server(s) 306 can include database 308. Database 308 can store data related to the functionalities of claims analysis server(s) 306. For example, database 308 can include open claims set 102 and/or SFC set 106 of FIG. 1. Third-party information server(s) 310 and database 312 can include various entities related to insurance claims analysis). For example, third-party information server(s) 310 can be managed by local government entities (e.g. local police), other insurance companies, and/or other sources of information regarding a claim.

It is noted that system 300 can, in some embodiments, be extended to address other needs within the insurance industry (e.g. underwriting and marketing for risk profiling/selection and/or customer retention respectively). For example, system 300 can be configured to analyze risk so as to make effective decisions on underwriting transaction and/or provide additional intelligence to the claims validation process. System 300 can also be extended to address other needs within healthcare industry for clinical trials/disease/genomics correlations, medical fraud and anomaly detection. Accordingly, system 300 (as well as process 100, etc.) is not restricted to the insurance industry alone, but also can be applied to other areas such as self-insured industry, law enforcement, state prison system and/or other areas where the ARM and MO methods and system provided herein can be applied to claims and anomaly detection.

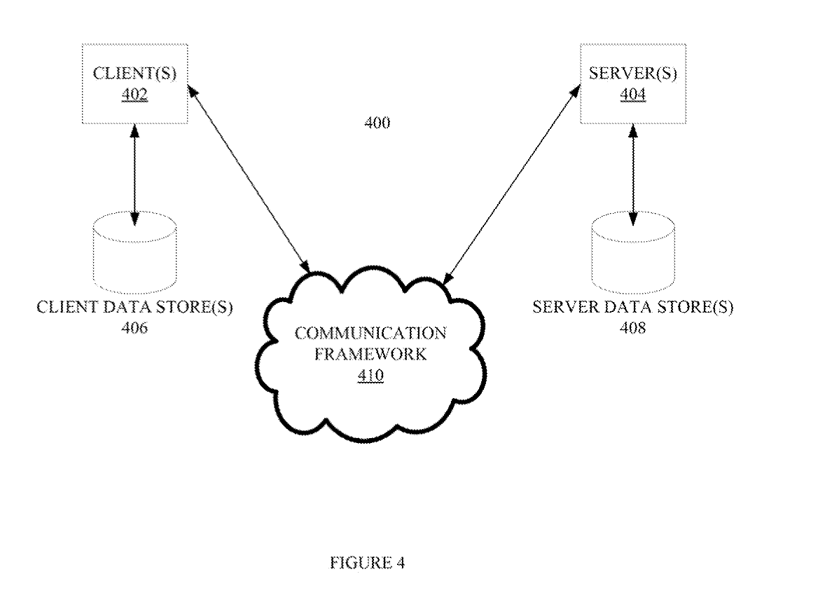

FIG. 4 is a block diagram of a sample computing environment 400 that can be utilized to implement various embodiments. The system 400 further illustrates a system that includes one or more client(s) 402. The client(s) 402 can be hardware and/or software (e.g. threads, processes, computing devices). The system 400 also includes one or more server(s) 404. The server(s) 404 can also be hardware and/or software (e.g. threads, processes, computing devices). One possible communication between a client 402 and a server 404 may be in the form of a data packet adapted to be transmitted between two or more computer processes. The system 400 includes a communication framework 410 that can be employed to facilitate communications between the client(s) 402 and the server(s) 404. The client(s) 402 are connected to one or more client data store(s) 406 that can be employed to store information local to the client(s) 402. Similarly, the server(s) 404 are connected to one or more server data store(s) 408 that can be employed to store information local to the server(s) 404.

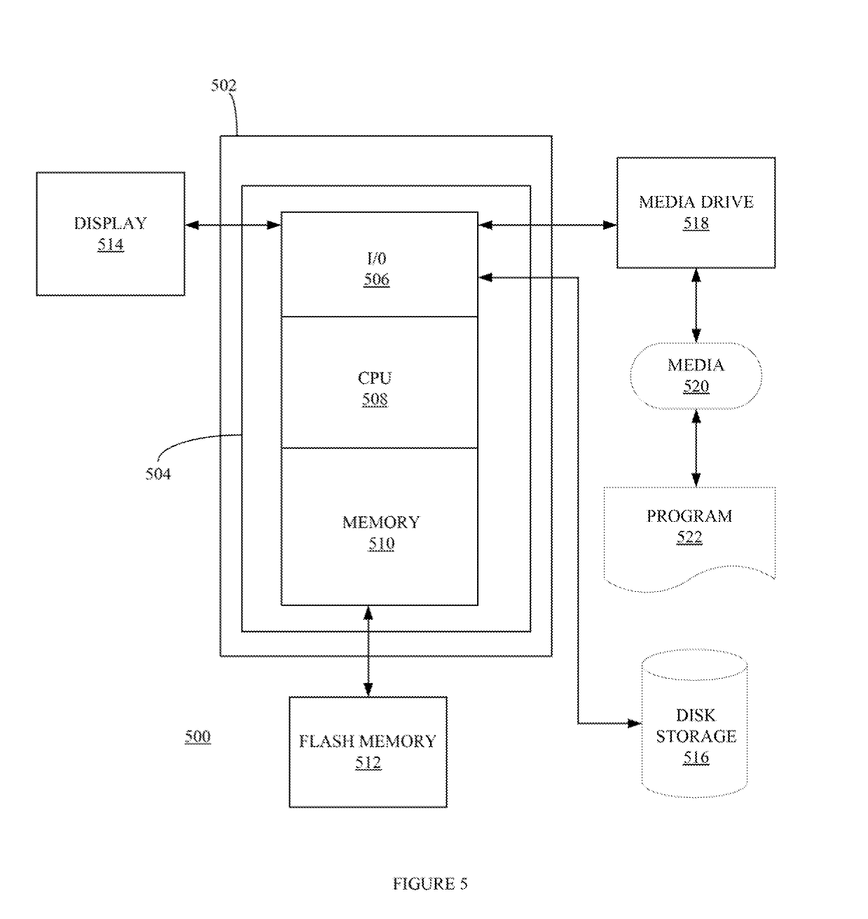

FIG. 5 depicts an exemplary computing system 500 that can be configured to perform any one of the processes provided herein. In this context, computing system 500 may include, for example, a processor, memory, storage, and I/O devices (e.g. monitor, keyboard, disk drive, Internet connection, etc.). However, computing system 500 may include circuitry or other specialized hardware for carrying out some or all aspects of the processes. In some operational settings, computing system 500 may be configured as a system that includes one or more units, each of which is configured to carry out some aspects of the processes either in software, hardware, or some combination thereof.

FIG. 5 depicts computing system 500 with a number of components that may be used to perform any of the processes described herein. The main system 502 includes a motherboard 504 having an I/O section 506, one or more central processing units (CPU) 508, and a memory section 510, which may have a flash memory card 512 related to it. The I/O section 506 can be connected to a display 514, a keyboard and/or other user input (not shown), a disk storage unit 516, and a media drive unit 518. The media drive unit 518 can read/write a computer-readable medium 520, which can contain programs 522 and/or data. Computing system 500 can include a web browser. Moreover, it is noted that computing system 500 can be configured to include additional systems in order to fulfill various functionalities. Computing system 500 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

Additional Methods

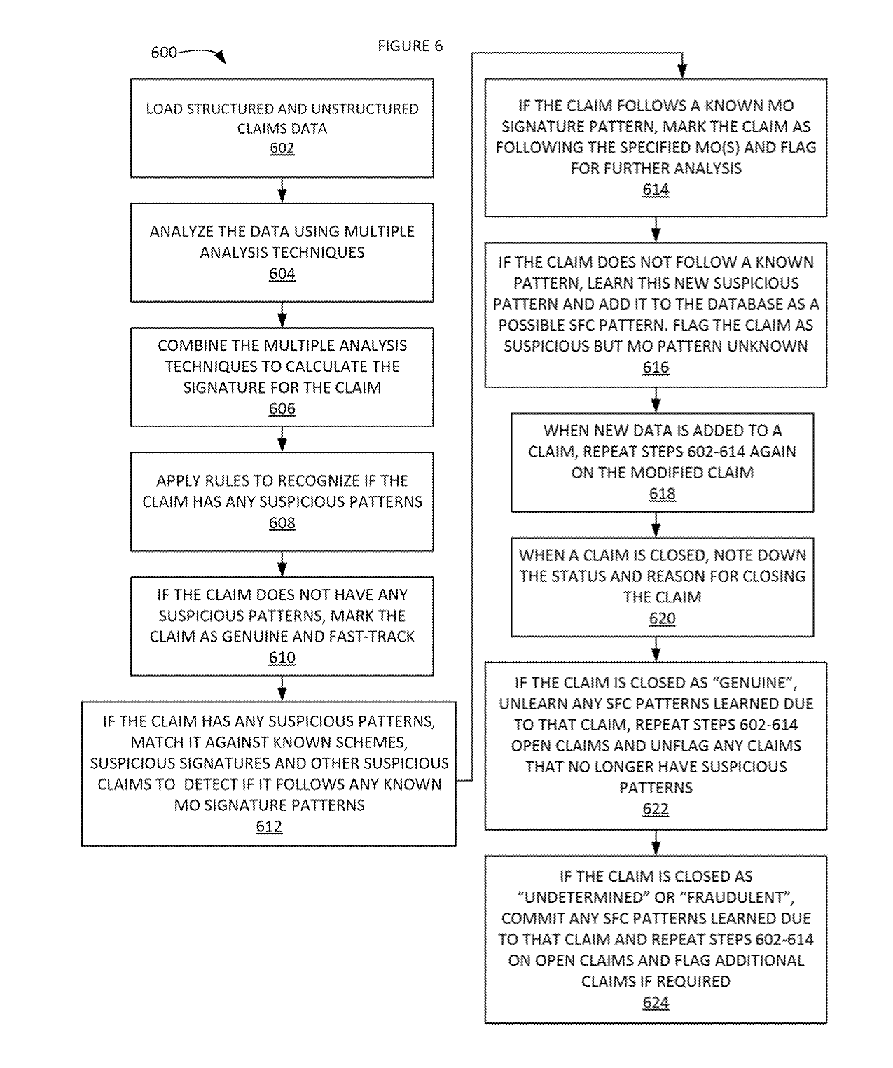

FIG. 6 illustrates an example process 600 for insurance and anomaly detection methods, according to some embodiments. In step 602, process 600 can load structured and unstructured claims data into a fraud-detection system. In step 604, process 600 can analyze the data using multiple analysis techniques. The advanced analyses techniques include text (including natural language processing), link, social, medical, transaction and predictive. In step 606, process 600 can combine the multiple analysis techniques to calculate the signature for the claim. In step 608, process 600 can apply rules to recognize if the claim has any suspicious patterns (e.g. using one or more pattern matching algorithms, etc.). If the claim does not have any suspicious patterns, then in step 610, process 600 can mark the claim as genuine and fast-track the claim. If the claim has any suspicious patterns, then in step 612, process 600 can match it against known schemes, suspicious signatures and other suspicious claims to detect if it follows any known modus operandi signature patterns. If the claim follows a known modus operandi signature pattern, then in step 614, process 600 can mark the claim as following the specified modus operandi(s) and flag for further analysis. If the claim does not follow a known pattern, then in step 616, process 600 can learn this new suspicious pattern and add it to the database as a possible SFC pattern. Process 900 can flag the claim as suspicious but modus operandi pattern unknown. When new data (e.g. based on investigator notes) is added to a claim, then in step 618, process 600 repeat steps 602-616 again on the modified claim

When a claim is closed, in step 620, process 600 can note down the status and reason for closing the claim (e.g. in a database). If the claim is closed as “genuine”, then in step 622, process 600 can unlearn any SFC patterns learned due to that claim. Process 600 can perform steps 602-614 again on all open claims and unflag any claims that no long include suspicious issues (e.g. given the new known SFC patterns set with this SFC pattern removed). If the claim is closed as “undetermined” or “fraudulent”, then in step 624, process 600 can commit any SFC patterns learned due to that claim. Process 600 can repeat steps 602-614 on all open claims and flag additional claims if required.

An example method of calculating a signature is now provided. A combination of several characteristics make up a pattern which is the claim signature. These characteristics can each have a vector value. This vector value can be based on the advanced analysis techniques used. An advanced analysis techniques can include, inter alia: text analysis, link analysis, social analysis, medical analysis and/or transactional analysis. The characteristics can be added or deleted based on each customer's business. The domain specific algorithms can be implemented behind each characteristic and its value can be updated based on customer's requirements. Each characteristic that contributes to the signature can uses single/multiple analysis techniques for determining the value. Once signature patterns are stored for a customer, these patterns can be used as the training set. Machine learning algorithms (e.g. in an intelligent claims validation systems product) can learn the analysis, recognition and resolution of these patterns to recommend course of action and its learning to enable the users. An example of signature can be found supra, where each characteristics of the claim signature is the MO Indicator.

Various Applications of ARM approaches can be implemented. These can include, inter alia: intelligent claims validation systems product ARM architecture and the signature concept (e.g. as discuss supra) can be extended for insurance carriers, state funds, city, county workers compensation claims, healthcare, life sciences, pharmacy, life insurance, and anywhere where patterns are needed to be determined.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g. embodied in a machine-readable medium).

In addition, it can be appreciated that the various operations, processes, and methods disclosed herein can be embodied in a machine-readable medium and/or a machine accessible medium compatible with a data processing system (e.g. a computer system), and can be performed in any order (e.g. including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A method of computer-implemented insurance claim validation based on ARM (pattern analysis, recognition and matching) approach and anomaly detection based on modus operandi analysis comprising:
obtaining a set of open claims data;
determining one of more modus-operandi variables of the open claims set;
determining a match between the one or more modus operandi variables and a claim in the set of open claims;
generating a list of suspected fraudulent claims that comprises each matched claim;
implementing one or more machine learning algorithms to learn a fraud signature pattern in the list of suspected fraudulent claims; and
grouping the set of open claims data based on the fraud signature pattern as determined by the modus operandi variables.

2. The method of claim 1 further comprising:
implementing one or more machine learning algorithms to learn a non-fraud signature pattern in the list of suspected fraudulent claims.

3. The method of claim 2 further comprising:
grouping the set of open claims data based on the non-fraud signature pattern.

4. The method of claim 3, wherein text analysis, social analysis, link analysis, statistical analysis, transaction analysis and predictive analyses is used to determine the modus-operandi variables of the open claims set.

5. The method of claim 4 further comprising:
providing another list of list of suspected fraudulent claims.

6. The method of claim 6 further comprising:
comparing the list of suspected fraudulent claims with the other list of suspected fraudulent claims and based on these comparisons a group of suspected fraudulent claims is grouped based on a similarity of the list of suspected fraudulent claims and the other list of suspected fraudulent claims.

7. The method of claim 7, wherein the set of open claims data comprises both structured and unstructured claims data.

8. A computerized system comprising:
a processor configured to execute instructions;
a memory containing instructions when executed on the processor, causes the processor to perform operations that:
obtain a set of open claims data;
determine one of more modus-operandi variables of the open claims set;
determine a match between the one or more modus operandi variables and a claim in the set of open claims;
generate a list of suspected fraudulent claims that comprises each matched claim;
implement one or more machine learning algorithms to learn a fraud signature pattern in the list of suspected fraudulent claims; and
group the set of open claims data based on the fraud signature pattern.

9. The computerized system of claim 8, wherein the memory containing instructions when executed on the processor, causes the processor to perform operations that:
implement one or more machine learning algorithms to learn a non-fraud signature pattern in the list of suspected fraudulent claims.

10. The computerized system of claim 9, wherein the memory containing instructions when executed on the processor, causes the processor to perform operations that:
group the set of open claims data based on the non-fraud signature pattern.

11. The computerized system of claim 10, wherein text analysis, social analysis, link analysis, statistical analysis, transaction analysis and predictive analyses is used to determine the modus-operandi variables of the open claims set.

12. The computerized system of claim 11, wherein the memory containing instructions when executed on the processor, causes the processor to perform operations that:
provide another list of list of suspected fraudulent claims.

13. The computerized system of claim 12, wherein the memory containing instructions when executed on the processor, causes the processor to perform operations that:
compare the list of suspected fraudulent claims with the other list of suspected fraudulent claims and based on these comparisons a group of suspected fraudulent claims is grouped based on a similarity of the list of suspected fraudulent claims and the other list of suspected fraudulent claims.

14. The computerized system of claim 13, wherein the set of open claims data comprises both structured and unstructured claims data.
